(19) United States
(12) Patent Application Publication
(10) Pub. No.: US 2026/0284715 A1
(43) Pub. Date: Sep. 24, 2026

(54) SYSTEM AND APPARATUS FOR AND METHOD OF CLEANING AIR FILTERS

(71) Applicant: Kenneth Hunter, Mississauga (CA)

(72) Inventor: Kenneth Hunter, Mississauga (CA)

(21) Appl. No.: 17/175,432

(22) Filed: Feb. 12, 2021

(30) Foreign Application Priority Data
Mar. 27, 2020 (CA) 3077210

(51) Int. Cl. B08B 5/02; B08B 7/00; B08B 7/04

(52) U.S. Cl. CPC B08B 5/02; B08B 7/0071; B08B 7/04

(57) ABSTRACT

A system for cleaning a filter used to clean air comprises an ultrasonic bath for performing initial cleaning of the filter, a rinse apparatus for rinsing contaminants from the filter subsequent to the initial cleaning of the filter and an apparatus for extracting moisture and contamination from the filter. The filter is supported in a filter-receiving chamber by a filter support for cleaning and drying of the filter in an air flow circulation path. Monitoring and confirming the back flow pressure of the filter at predetermined times or in real time while the apparatus is in use.

### FIELD OF THE INVENTION

The present invention relates to cleaning air filters, and more particularly to cleaning air filters, such as exhaust filters, that may be used in conjunction with internal combustion engines.

### BACKGROUND OF THE INVENTION

Air filters, such as exhaust filters, or in other words filters that are used to trap contaminants such as particulate matter, including soot and the like, are used in many places including on diesel engines, in refined-gas lines, and so on.

Air filters, such as exhaust filters, used in conjunction with diesel engines are used to lower particulate matter emissions from diesel engines, including both inorganic and organic particulate matter from the exhaust gas stream of a diesel engine. The filter is tailored to particular requirements as determined by the specific parameters of the diesel engine, to maintain the most favorable exhaust backpressure for the engine and exhaust system.

Typically, such filters include a housing containing a substrate with various passages for the exhaust to travel through. The porous substrate in the interior of the filter consists of thousands of small parallel channels, typically oriented along the longitudinal direction of the filter. Adjacent channels in the filter are alternately plugged at each end. This arrangement of channels and porous walls forces the exhaust gases to flow through the porous walls. The porous walls act as the medium for filtering out the particulates that are too big to pass through the porous walls, which remain deposited in the channels.

In order to use such filters for their entire useful lifespan, the filters must be cleaned periodically. It is known to use an ultrasonic bath to clean these types of filters, along with subsequently rinsing and drying the filters. It is also known to use a rotatable air knife to dry the filers.

U.S. Pat. No. 6,990,751 issued Jan. 31, 2006, to Rileyet al., and entitled Rotatable Air Knife, discloses an air knife or air nozzle manifold for drying or blowing off passing articles moved by a conveyor system. A coupling permits rotation of the air knife or air nozzle manifold relative to the air inlet duct leading from a blower. The air knife or air nozzle manifold has opposing ends located equidistant from a longitudinal axis of rotation relative to a stationary element of the coupling. Thrust nozzles are provided at each of the opposing ends of the air knife or air nozzle manifold to deflect a certain portion of the air from the plenum chamber to provide thrusting jets of air that rotate the air knife or air nozzle manifold about the longitudinal axis. The flow of air emitted from the air knife or air nozzle manifold is thereby directed onto the passing articles from different directions as the articles move by. The efficiency of drying and blowing off the articles to be processed is thereby significantly improved.

U.S. Pat. No. 6,260,231 issued Jul. 17, 2001, to Bybee et al., and entitled Air Knife Drying System, discloses a system for drying printed circuit boards in a liquid cleaning apparatus. The liquid cleaning apparatus includes a series of air knife dryers enclosed within two drying modules. The first drying module houses a first set of top and bottom air knife dryers which includes at least one top air knife dryer, positioned above a conveyor belt carrying printed circuit boards through the liquid cleaning apparatus, and at least one bottom air knife dryer, positioned below the conveyor belt. The air knife dryers may be symmetrically opposed and aligned above and below the conveyor belt. The liquid cleaning apparatus further includes side air knife dryers disposed along the conveyor belt between the first drying module and the second drying module.

U.S. Pat. No. 5,074,242 issued Dec. 24, 1991, to Bricmont, and entitled Air Knife, discloses an air knife formed of a plurality of independently controllable pressure chambers for permitting gas in an assortment of differential pressures to be simultaneously discharged from separate segmental portions along the length of the air knife nozzle in order to produce an essentially uniform and desired coating thickness on a continuously moving and continuously coated work piece regardless of strip thickness, width, camber, and velocity. The air knife includes a plurality of baffles positioned inside the barrel of the air knife for dividing the barrel into at least three distinct pressure chambers. The baffles are adjustably positionable along the length of the barrel in order to establish the desired segmental lengths along the air knife nozzle from which the differentially pressurized gas is discharged from the air knife. In the first illustrated embodiment, a computer continuously adjusts and controls the pressure in each chamber, and the position of air knife with respect to the workpiece.

Canadian published Patent Application No. 2,867,961, published Apr. 16, 2015 to Hunter, discloses a System For Extracting Contaminants From Contaminant-Trapping Filters. The system comprises a contaminant-receiving container; a filter support apparatus for supporting a contaminant-trapping filter in contaminant-depositing relation with respect to the contaminant-receiving container; an air nozzle for directing a flow of air through the contaminant-trapping filter, thereby forcing contaminants from the contaminant-trapping filter; wherein, in use, a contaminant-trapping filter is placed, using the filter support apparatus, in contaminant-depositing relation with respect to the contaminant-receiving container, and air is blown by the air nozzle through the contaminant-trapping filter, to thereby substantially evacuate residual contaminants from the contaminant-trapping filter, for retention of the contaminants in the contaminant-receiving container.

It is also known to use systems and methods for cleaning filters wherein an air knife is not used.

U.S. Pat. No. 5,372,653 issued Dec. 13, 1994, to Gray, and entitled Cleaning Of Filters, discloses a method of cleaning metal filters of a solvent spun fibre production plant. The method comprises the step of (a) dissolving dope from the filters using a hot solvent for the dope, (b) washing the solvent from the filters using hot water, (c) pyrolysing remnants of dope or solvent in the filters, (d) ultrasonically washing the pyrolysed particles from the filters, (e) reheating the filters to dislodge pyrolysed particles, (f) ultrasonically rewashing the filters and (g) drying the filters.

U.S. Pat. No. 5,182,832 , issued Feb. 2, 1993, to McMahon, and entitled Air Filter Cleaning Apparatus. The apparatus as disclosed has an inlet tube having a connector at one end for coupling to an air supply hose, and a rotary head is rotatably mounted on the other end of the inlet tube. The rotary head has an internal air distribution chamber connected to the inlet tube and small outlet openings in its outer peripheral wall for spraying air from the chamber towards an air filter unit. Rotor or spin outlet passageways in the peripheral wall are arranged at an angle to cause the head to spin in a turbine-like fashion when air flow is directed from the chamber and out through the passageways. The rotating head sprays air outwardly across the surface of an air filter unit to dislodge dirt from filter paper in a filter unit.

United States published Patent Application No. 20150000701, published Jan. 1, 2015 to Tevely et al, discloses a Method And Apparatus For Cleaning Diesel Particulate Filters. In that document, there is taught an apparatus and method for removing accumulated ash and soot from DPFs which uses a combination of ultrasonic energy coupled via a liquid cleaning solution to the internal and external surfaces of the DPF to dislodge and remove the accumulated materials, and a system of directing clean solution for rinsing of the filter elements by continuous filtration of the rinse solution, and a means of drawing residual material-laden cleaning solution from the filter to complete the cleaning process.

It is an object of the present invention to provide a system and apparatus for and method of cleaning air filters.

It is an object of the present invention to provide a system and apparatus for and method of cleaning air filters, such as exhaust filters.

It is an object of the present invention to provide a system and apparatus for and method of cleaning air filters, wherein contaminants such as particulate matter are thoroughly removed from the filters.

It is an object of the present invention to provide a system and apparatus for and method of cleaning air filters, such as exhaust filters, wherein water used to rinse the filters is thoroughly removed from the filters so the filters are at least close to dry.

It is an object of the present invention to provide a system and apparatus for and method of cleaning air filters, such as exhaust filters, and mare particularly such as filters used in diesel engines.

It is an object of the present invention to provide a system and apparatus for and method of cleaning air filters, such as exhaust filters, wherein the system and apparatus are inexpensive to manufacture.

It is an object of the present invention to provide a system and apparatus for and method of cleaning air filters, such as exhaust filters, wherein the system and apparatus are inexpensive to maintain.

It is an object of the present invention to provide a system and apparatus for and method of cleaning air filters, such as exhaust filters, wherein the system and apparatus are inexpensive to operate.

It is an object of the present invention to provide a system and apparatus for and method of cleaning air filters, such as exhaust filters, wherein the method is inexpensive to implement and execute.

### SUMMARY OF THE INVENTION

In accordance with one aspect of the present invention there is disclosed a novel apparatus for cleaning air filters. The apparatus comprises a housing having a filter-receiving chamber that surrounds a filter to be cleaned and dried, an air flow ingress in fluid communication with the filter-receiving chamber, and an air flow egress in fluid communication with the filter-receiving chamber. An air flow conduit connects the air flow egress in air delivery relation to the air flow ingress. The air flow ingress, the housing includes the filter-receiving chamber, and air flow conduit form a closed-loop air flow circulation path. A filter support in the housing supports the filter to be cleaned and dried in the air flow circulation path. A fan circulates air along the air flow circulation path. A heater heats the air circulating air along the air flow circulation path. A contaminant filtration apparatus in the air flow circulation path captures contaminants in the air circulating in the air flow circulation path. A control device for controls the operation of the fan and heater.

In accordance with another aspect of the present invention there is disclosed a novel system for cleaning air filters. The system comprises an ultrasonic bath for performing initial cleaning of the filter, a rinse apparatus for rinsing contaminants from the filter subsequent to the initial cleaning of the filter and an apparatus for extracting moisture and contamination from the filter. The filter is supported in a filter-receiving chamber by a filter support for cleaning and drying of the filter in an air flow circulation path.

In accordance with another aspect of the present invention there is disclosed a novel method of cleaning air filters. The method comprises the steps of placing the filter on a filter support in a filter-receiving chamber in an air flow circulation path; heating air for subsequent circulation along the filter; circulating air along the filter to thereby evaporate moisture from the filter and remove contamination from the filter; and capturing contaminants in the air circulating in the air flow circulation path.

In accordance with another aspect of the present invention there is disclosed a novel method of cleaning air filters. The method comprises the steps of (a) initially ultrasonically cleaning the filter; (b) subsequently to step (a), rinsing contaminants and ultrasonic cleaning solution from the filter; and (c) subsequently to step (b), circulating air along the filter to thereby evaporate moisture from the filter and remove contaminants from the filter.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a first illustrated embodiment of the invention will now be illustrated by way of example. It is expressly understood, however, that the drawings are for the purpose of illustration and description only, and are not intended as a definition of the limits of the invention. In the accompanying drawings:

FIG. 1 is a front elevational view of the illustrated embodiment of the system and apparatus for and method of cleaning air filters according to the present invention;

FIG. 2 is a perspective view from the front right of the illustrated embodiment of the apparatus of FIG. 1;

FIG. 3 is a perspective view from the front left of the illustrated embodiment of the apparatus of FIG. 1;

FIG. 4 is a front elevational view of the illustrated embodiment of the apparatus of FIG. 1;

FIG. 5 is a sectional front elevational view of the illustrated embodiment of the apparatus of FIG. 1;

FIG. 6 is a side elevational view of the illustrated embodiment of the apparatus of FIG. 1;

FIG. 7 is a top plan view of the illustrated embodiment of the apparatus of FIG. 1;

FIG. 8 is a perspective view from the front left of the housing of the illustrated embodiment of the apparatus of FIG. 1;

FIG. 9 is a front elevational view of the illustrated embodiment of the system, apparatus and method of FIG. 1, showing the system and apparatus in use according to the present method; and,

FIG. 10 is sectional front elevational view of the illustrated embodiment of the apparatus of FIG. 1, showing the apparatus in use.

### LIST OF COMPONENTS AND REFERENCE NUMERALS

100 System
106 Filter(s)
110 Ultrasonic bath
112 Rectangular tank
114 Substantially hollow interior
115 Ultrasonic transducers
116 Hinged lid
120 Substantially horizontal boom arm
122a First mounting end
122b Second mounting end
126 Tracks
128 Crank handle
129a First support structure
129b Second support structure
130 Winch apparatus
132 Jaw mechanism
140 Rinse apparatus
142 Nozzle
150 Apparatus
152 Housing
153a Front
153b Back
154a Left side
154b Right side
155a Top
155b Bottom
157d Door
157f Frame
157p Panels
158a Air flow ingress
158b Air flow egress
160 Filter-receiving chamber
162 Heater
168 Filter support
170 Collection chamber
172 Contaminant filtration apparatus
176 Sump pump
177 Flexible tube
177a Inlet
180 Fan encasement chamber
182 Fan
183 Electric motor
184 Control device
186 Control panel
187 Green, yellow and red lights
187r Red light
187y Yellow light
187g Green light
188 Air flow conduit
190 Air pressure monitor
191 First hose
191a Inlet
192 Second hose
192a Inlet
196 First supplemental air flow conduit
196c Capped outlet
198 Second supplemental air flow conduit
198c Capped outlet

### DETAILED DESCRIPTION OF THE ILLUSTRATED EMBODIMENT

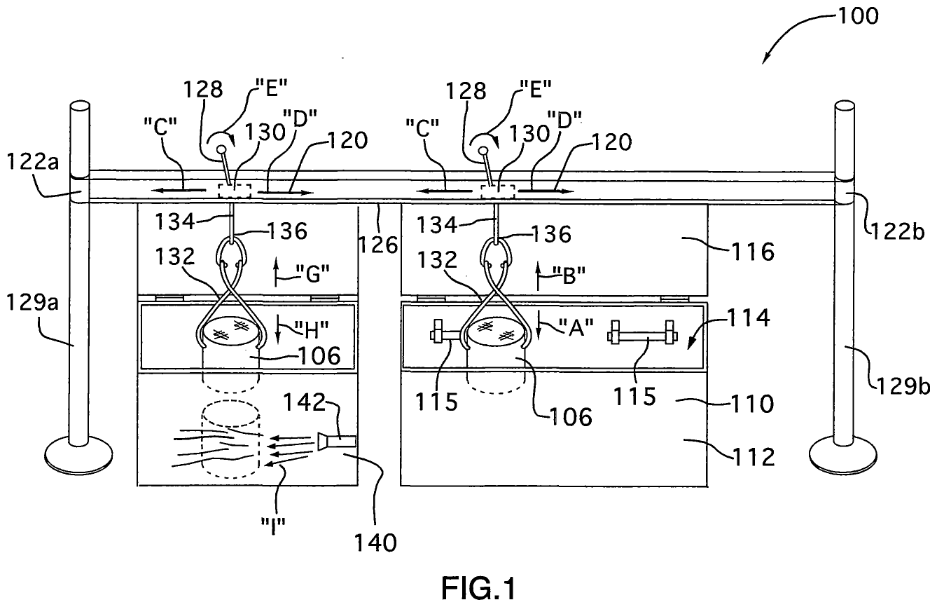

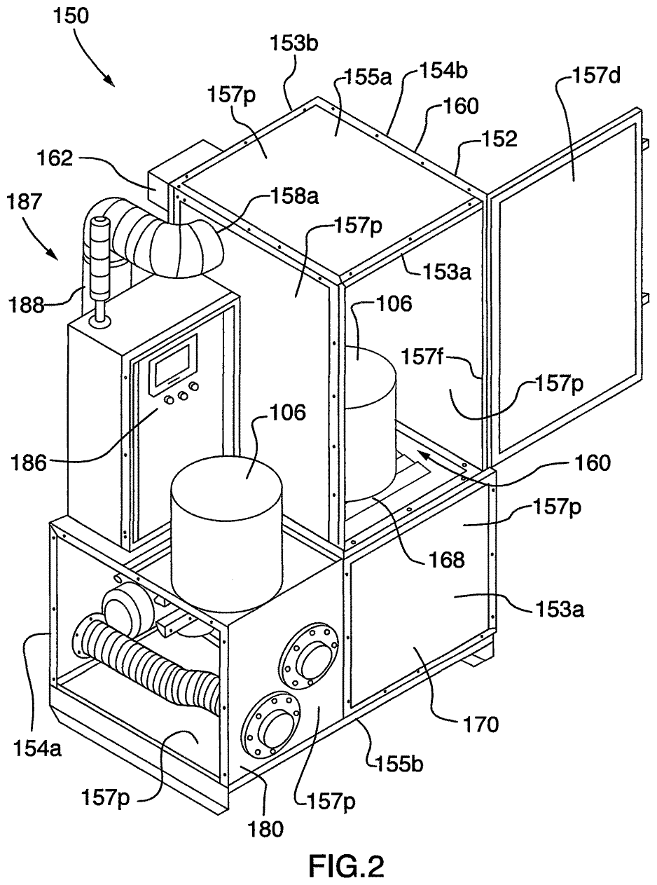

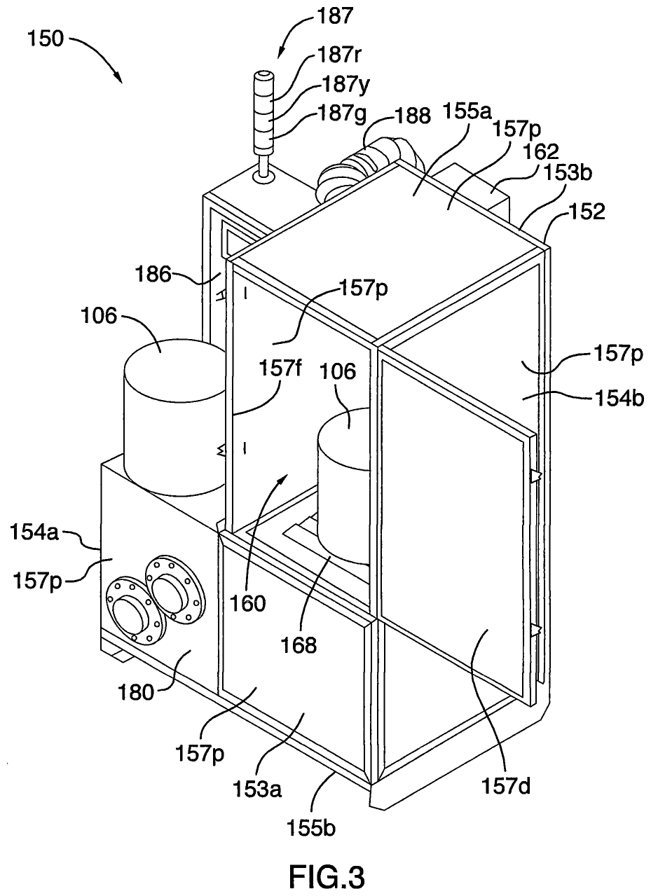

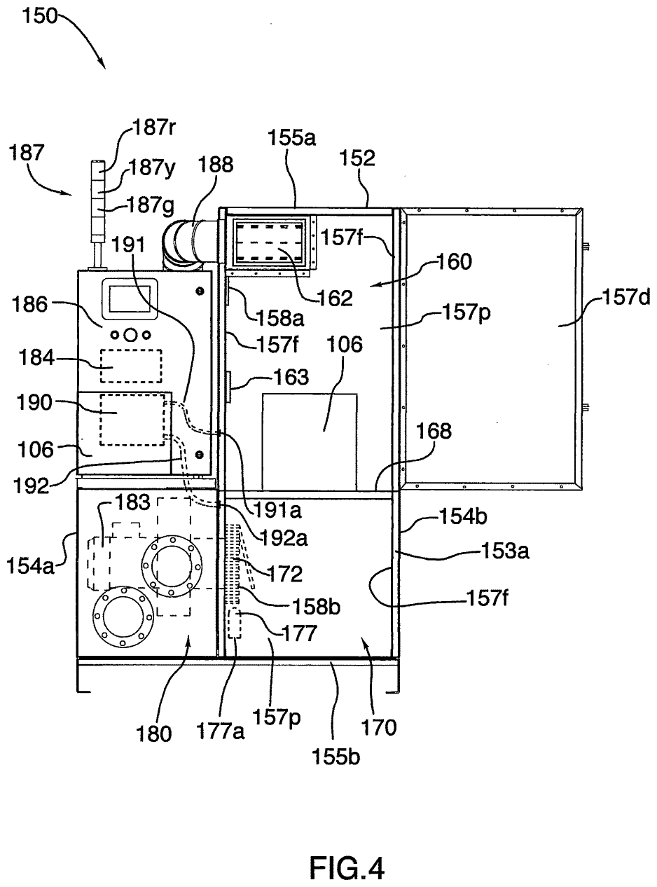

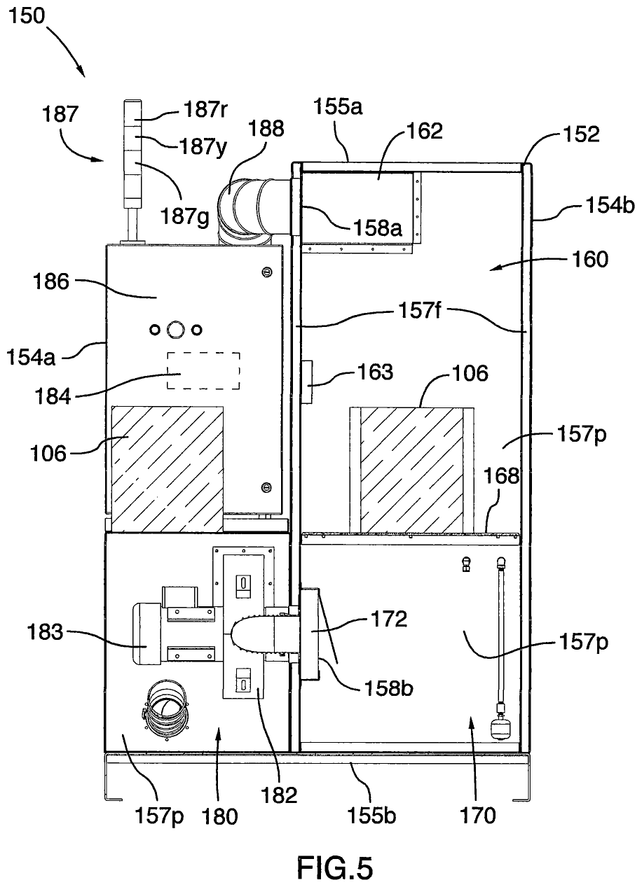

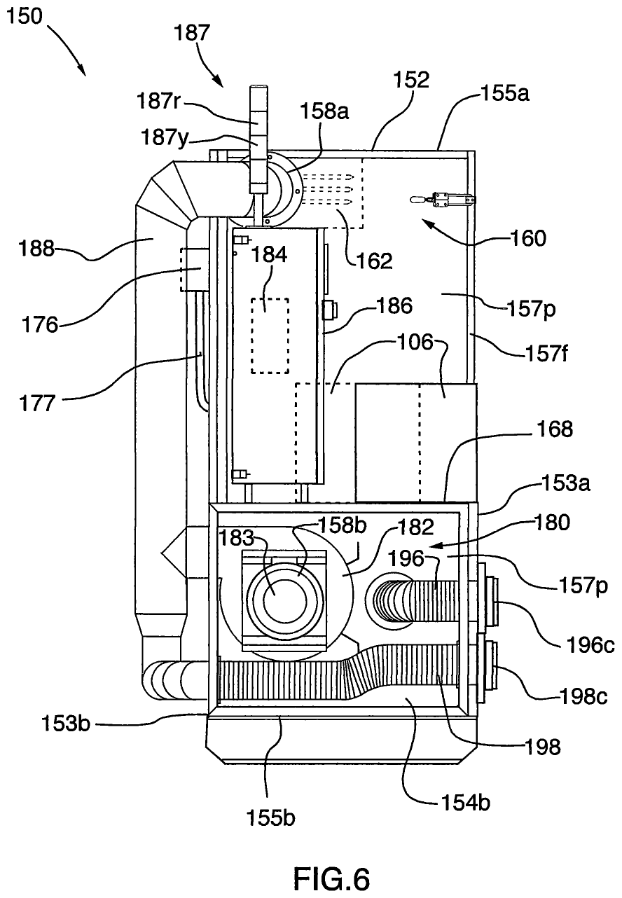

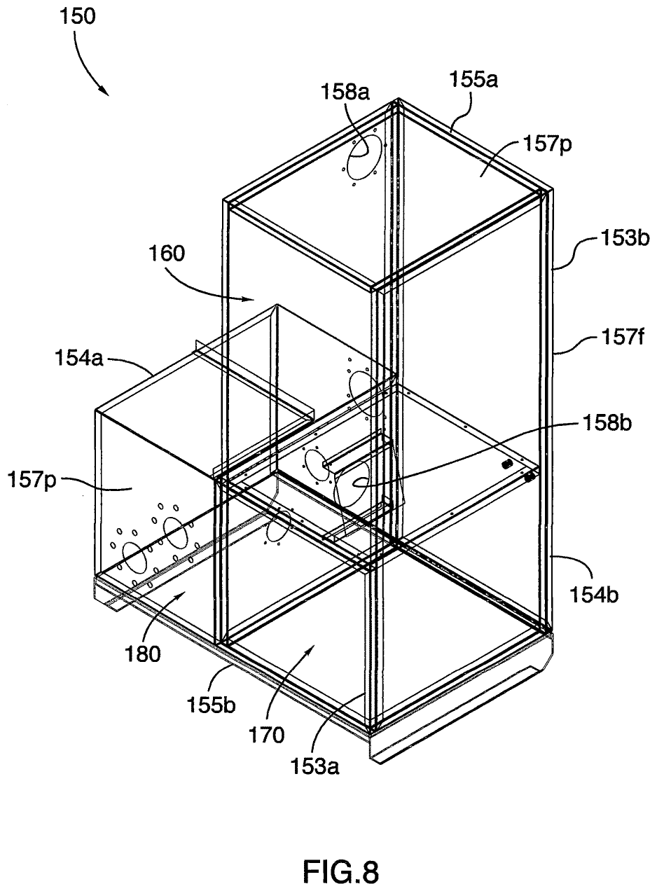

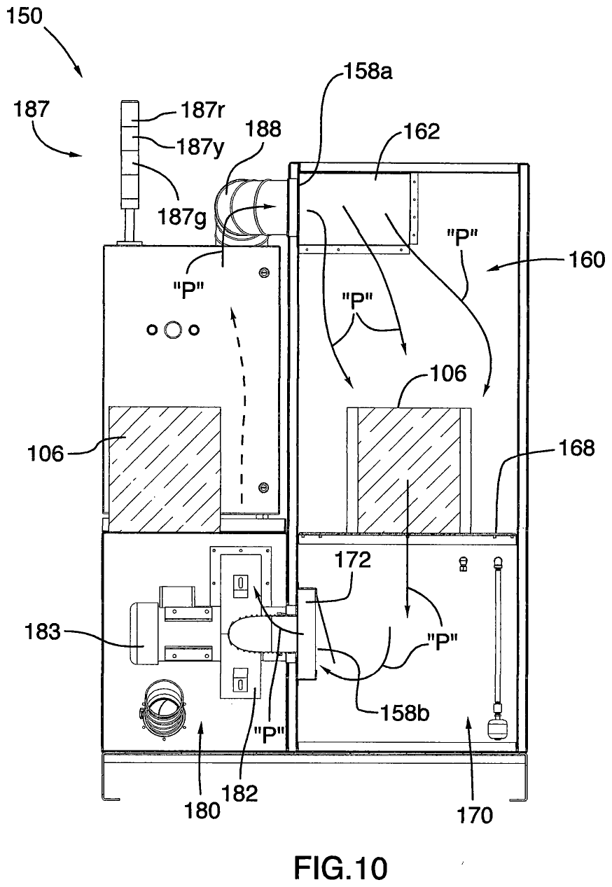

Reference will now be made to FIGS. 1 through 10, which show the illustrated embodiment of the present invention, as indicated by general reference numeral 100. The present invention comprises system 100 is for cleaning air filters. In the illustrated embodiment, and for the sake of clarity, filters 106 that may be used in used in in conjunction with internal combustion engines, such as diesel engines, will be discussed, although the system may be used for extracting contaminants from other types of air filters. Accordingly, the illustrated embodiment of the system 100 and apparatus 150 and method for cleaning air filters according to the present invention, as discussed and illustrated, is for extracting contaminants such as particulate matter from the filters, and also drying the filters 106.

In one aspect of the present invention, there is disclosed a system 100 for cleaning air filters 106. The system 100 may comprise an ultrasonic bath 11 for performing initial cleaning of the filter 106, a rinse apparatus 140 for rinsing contaminants from the filter 106 subsequent to the initial cleaning of the filter 106 and an apparatus 150 for extracting moisture and contamination from the filter 106, as described above. The filter 106 may be supported in a filter-receiving chamber 160 by a filter support 168 for cleaning and drying of the filter 106 in an air flow circulation path “P”, which may be a closed-loop air flow circulation path “P”. There may also be a pad 169 made of a pliable material such as a rubber material or a rubber compound material, or the like, with a central aperture 169a therein. The central aperture 169a may be about the same size or slightly smaller than the filter 106. The filter 106 may rest on the pad 169 or within the central aperture 169a so as to be in substantially sealed relation with respect to the pad 169. Accordingly, all of the air flow in the closed-loop air flow circulation path “P” may flow through the filter 106.

More particularly, the system 100 may comprise an ultrasonic bath 110 for loosening and dislodging contaminants from the filter 106. The ultrasonic bath 110 consists of a rectangular tank 112 of appropriate size to contain up to five filters 106 therein. It has been found that rectangular tank 112 of about sixty inches in length, thirty inches in width and twenty-eight inches in depth is suitable. Any other suitable size could be used.

The rectangular tank 112 has a substantially hollow interior 114 and has a hinged lid 116 for covering the substantially hollow interior 114 of the tank 112 during use. Ultrasonic transducers 115 are mounted within the rectangular tank 112. An electrically operable winch apparatus 130 is mounted within a substantially horizontal boom arm 120. The controls for the electrically operable winch apparatus 130 may be mounted in any convenient location. The winch apparatus 130 is used to lower the filters 106 into the ultrasonic bath 110, as indicated by arrow “A” in FIG. 1, and to raise the filters 106 from the ultrasonic bath 110, as indicated by arrow “B” in FIG. 1, thereby removing the filters 106 from the ultrasonic bath 110.

The substantially horizontal boom arm 120 has a first mounting end 122a and a second mounting end 122b, and tracks 126 within the boom arm 120 to permit horizontal travel of the winch apparatus 130 along the substantially horizontal boom arm 120 generally between the first mounting end 122a and the second mounting end 122b. The electrically operable winch apparatus 130 is mounted on the horizontal boom arm 120 by means of the tracks 126 within the boom arm 120, for selective movement along the boom arm 120, as indicated by arrows “C” and by arrows “D” in FIG. 1, by means of a manual crank mechanism having a crank handle 128 mounted adjacent the mounting end 122 of the boom arm 120. The motion of the crank handle 128 is indicated by arrow “E”.

Alternatively, the winch 130 could be moved along the tracks 126 by a selectively operable electric motor (not specifically shown).

The boom arm 120 may be mounted at its first mounting end 122a on a first support structure 129a and at its second mounting end 122b on a second support structure 129b. The first support structure 129a and the second support structure 129b may be a vertical pole anchored to a floor. As shown in FIG. 1, the winch apparatus 130 is in position to raise and lower the filters 106, as discussed above, and in position to retain the filter 106 within the ultrasonic bath 110 for initially loosening contaminants from the filter 106, also is in position to deliver the filter 106 into the rinse station 140, as indicated by arrows “G and “H”.

Each filter 106 is clamped by a selectively operable jaw mechanism 132 connected to the free end 136 of the cable 134 from the winch apparatus 130. When a filter 106 is in place in the ultrasonic submerged position or in the contaminant extracting position, the filter 106 can be selectively released from the selectively operable jaw mechanism 132.

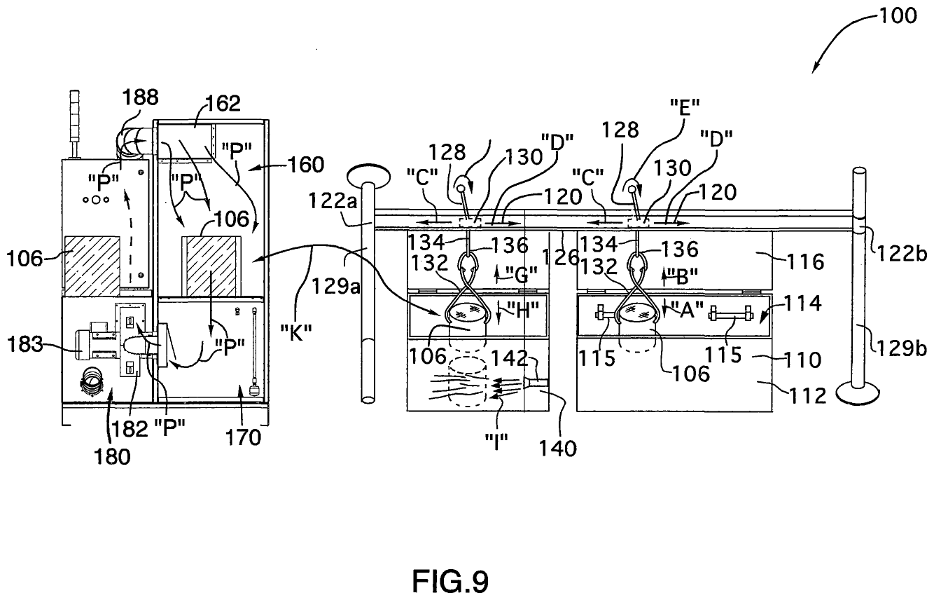

In another aspect of the present invention, there is disclosed a method of cleaning air filters 106, as is best seen in FIG. 9. The method may comprise the steps of initially ultrasonically cleaning the filter 106. This step may be performed in an ultrasonic bath, such as the ultrasonic bath 110. Another step may comprise, subsequently to the step of initially ultrasonically cleaning the filter 106, rinsing contaminants and ultrasonic cleaning solution from the filter 106. This step may be performed at a rinse station such as the rinse apparatus 140, after being transferred from the ultrasonic bath 110, as indicated by arrow “J” and allows a flow of water to pass from a nozzle 142 over the filter 106, as indicated by arrow “I”, in order to thoroughly rinse the filter. Another step may comprise, subsequently to the step of rinsing contaminants and ultrasonic cleaning solution from the filter 106, circulating air, as indicated by arrow “J”, and maybe heated air, along the filter 106 to thereby evaporate moisture from the filter 106 and remove contaminants from the filter 106. This step may be performed at the apparatus 150, after being transferred from the rinse apparatus 140, as indicated by arrow K”.

In another aspect of the present invention, there is disclosed an apparatus 150 for cleaning air filters 106. The apparatus 150 may comprise a housing 152 extending between a front 153a, a back 153b, a left side 154a, a right side 154b, a top 155a and a bottom 155b. The housing 152 may be divided into three chambers, which maybe a filter-receiving chamber 160, a collection chamber 170, and a fan encasement chamber 180. The filter-receiving chamber 160 may occupy the top portion of the housing 152 and may be disposed above the collection chamber 170 and may extend downwardly from the top 153a of the housing 152 to the collection chamber 170 and may extend inwardly from the right side 154b of the housing 152 towards the left side 154a. The collection chamber 170 may be disposed below the filter-receiving chamber 160 and may extend upwardly from the bottom 155b of the housing 152 to the filter-receiving chamber 160 and may extend inwardly from the right side 154b of the housing 152 to the fan encasement chamber 180. The fan encasement chamber 180 may be disposed beside the collection chamber 170 and may extend from the left side 154a of the housing 152 to the collection chamber 170 and may extend upwardly from the bottom 155b of the housing 152 to a top surface 156 used to receive filters 106 that are not in the filter-receiving chamber 160 (typically either before or after cleaning).

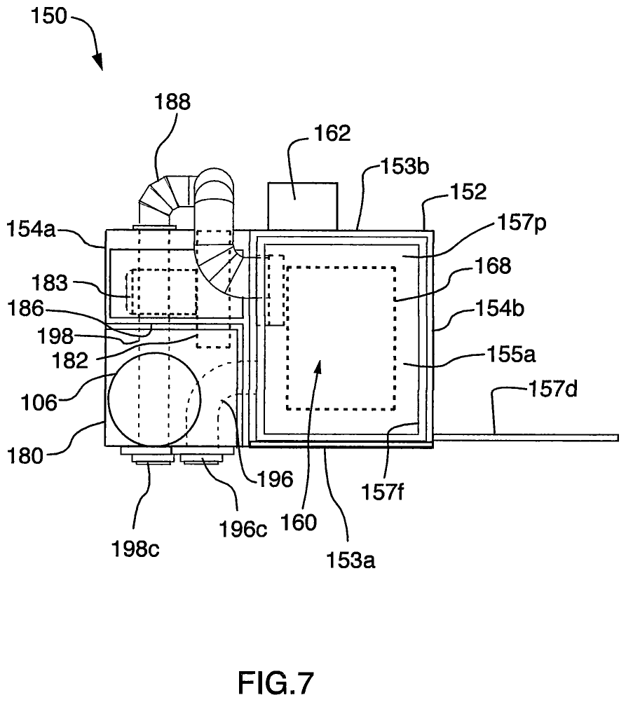

The housing 152 may have a frame 157f as may be best seen in FIG. 7, and may have a plurality of panels 157p secured to the frame 157f to make up the filter-receiving chamber 160, the collection chamber 170, and the fan encasement chamber 180. A door 157d may be operatively secured to the filter-receiving chamber 160 in openable and closable relation to permit access to the filter-receiving chamber 160 and to permit securely sealed closing off of the filter-receiving chamber 160 during use. The filter-receiving chamber 160 may surround a filter 106 to be cleaned and dried, so as to preclude the escape of particulate matter, moisture, and so on, from the air flowing in the closed-loop air flow circulation path “P”, as the filter 106 is being cleaned. The collection chamber 170 may be sealed to preclude the escape of particulate matter, moisture, and so on, from the air flowing in the closed-loop air flow circulation path “P”, after flowing through the filter 106. The collection chamber 170 may be used to collect, or in other words to receive and retain, particulate matter, moisture, and so on, from the air flowing in the closed-loop air flow circulation path “P”, after flowing through the filter 106. The collection chamber may have about thirty (30) litres of capacity, or any other suitable capacity. It has been found that the full cleaning of a filter 106 may produce about one (1) litre of particulate matter, moisture, and so on.

The housing 152 may have an air flow ingress 158a in the filter-receiving chamber 160. The air flow ingress 158a may be in fluid communication with the interior of the filter-receiving chamber 160. Also, the housing 152 may have an air flow egress 158b in the filter-receiving chamber 160. The air flow egress 158b may be in fluid communication with the filter-receiving chamber 160. The air flow ingress 158a and the air flow egress 158b may be in fluid communication each with the other. An air flow conduit 188 may connect the air flow egress 158b in air delivery relation to the air flow ingress 158a.

There may be a filter support 168 in the housing 152 for supporting the filter 106 to be cleaned and dried within the filter-receiving chamber 160 and in the closed-loop air flow circulation path “P”. The filter 106 may be supported as such by the filter support 168 for cleaning and drying of the filter 106 in the closed-loop air flow circulation path “P”. The filter support 168 may comprise a grate and additionally or alternatively may comprise a wire mesh. As can readily be seen in the figures, the filter support 168 may be disposed adjacent the bottom of the filter-receiving chamber 160 and may at least in part define the bottom extent of the filter-receiving chamber 160.

There may be a fan 182 for circulating air along the closed-loop air flow circulation path “P”. The fan 182 may comprise a suitable blower that may be connected in air receiving relation to the air flow egress 158b, and may be connected in air delivery relation to the air flow conduit 188. The blower may be rated at about 1900 cubic feet per minute (c.f.m.) and may be driven by a three (3) horsepower electric motor 183. This may be sufficient to extract any contaminants such as contaminants, including soot and ash, on or in the filter 106, and to dry the filter 106.

The air flow ingress 158a, the housing 152 including the filter-receiving chamber 160 and the collection chamber 170, the air flow egress 158b, the fan 182 and the air flow conduit 188 together form the closed-loop air flow circulation path “P”.

In order to heat the circulating air that may be circulating along the closed-loop air flow circulation path “P”, there may be a heater 162 disposed in the housing 152, and more specifically in the filter-receiving chamber 160. The heater 162 may be operatively disposed between the air flow ingress 158a and the filter-receiving chamber 160, and may be disposed in the closed-loop air flow circulation path “P” immediately after the air flow ingress 158a and the filter-receiving chamber 160. Further, the heater 162 may be disposed in the closed-loop air flow circulation path “P” to heat the circulating air as it enter the filter-receiving chamber 160. The heater 162 may be electrically powered or gas powered, or powered by any other suitable source of energy.

A contaminant filtration apparatus 172 may be disposed in the closed-loop air flow circulation path “P”, for capturing contaminants in the air circulating in the closed-loop air flow circulation path “P”. The contaminant filtration apparatus 172 may comprise a high temperature air filter 106 disposed over the air flow egress 158b.

The apparatus 150 may further comprise an air pressure monitor 190 for continuously or intermittently monitoring the air pressure at one or more points in the closed-loop air flow circulation path “P”. The air pressure monitor 190 may comprise an electronic pressure differential gauge mounted within the control panel 186. The electronic pressure differential gauge 190 may have a first input operatively connected in fluid communication via a first hose 191 to the filter-receiving chamber 160 at an inlet 191a. Further, the electronic pressure differential gauge 190 may have a second input operatively connected in fluid communication via a second hose 192 to the collection chamber 170. As air flows along the closed-loop air flow circulation path “P”, and through the filter 106, the air pressure monitor 190 may thereby detect the air pressure differential between the filter-receiving chamber 160 and the collection chamber 170. This pressure differential may be used to detect the back pressure, or in other words resistance to air flow, in the closed-loop air flow circulation path “P”. The back pressure reading for filters being tested may be about four (4) p.s.i. to about seven (7) p.s.i. for a clean filter, and may be higher for a partially clogged filter, and may be significantly higher for a very clogged filter. The back pressure reading will be compared to the OEM backpressure reading to determine the level of cleanliness of the filter.

There may also be a control device 184 for controlling the operation of the fan 182, the heater 162, and the air pressure monitor 190. The control device 184 may comprises a suitable electronic controller mounted within a control panel 186 that may be mounted on the fan encasement chamber 180. The control device 184 may connect by wire or wirelessly to a remote control unit, which may be a compute, a tablet, a smart phone, or the like (not specifically shown).

In order to remove particulate matter and/or other contaminants that fall from the flow of air and contaminants, a small sump pump 176, which may be a diaphragm pump, may be located in or on the housing 152. For ease of access, the sump pump 176 may be located on the back of the housing 152. The sump pump 176 may be connected in suctioning relation with the collection chamber 170 by a flexible tube 177 that may have an inlet 177a located adjacent the bottom area of the collection chamber 170. The sump pump 176 may be manually operated or may be operated periodically, such as once every ten to fifteen full cleaning cycles, to thereby remove the contaminants from the collection chamber 170. The outlet of the sump pump 176 may be connected in fluid delivery relation to the ultrasonic bath 110.

In a first mode of operation that may be used prior to cleaning the filter 106, the fan 182 may be operational but the heater 162 may not be operational in order to circulate a test flow of air through the closed-loop air flow circulation path “P”. The air pressure monitor 190, as controlled by the control device 184 measures the air pressure. The determined value of the air pressure may be displayed digitally or by analogue gauges on the control panel 186, may be communicated to the remote device and displayed, and/or displayed by a series of green, yellow and red lights 187. The red light 187r may indicate that the filter 106 may be retaining a large amount of contaminants, and may be clogged. The yellow light 187y may indicate that the filter 106 may be retaining a medium amount of contaminants. The green light 187g may indicate that the filter 106 may be retaining a low amount of contaminants, or even no contaminants.

In a second mode of operation, the fan 182 and heater 162 may be operated for a full cleaning cycle that may be a selected duration of time such as fifteen (15), thirty (30), forty-five (45) or sixty (60) minutes, for example. A temperature gauge 163 may be disposed at various points in the closed-loop air flow circulation path “P”, such as in the filter-receiving chamber 160, and may be used to determine the temperature of the airflow, which may be displayed digitally or by analogue gauges on the control panel 186, and/or may be communicated to the remote device. Further, the air pressure monitor 190 (electronic pressure differential gauge) may monitor air pressure measurements at various points in the closed-loop air flow circulation path “P”. As stated above, the electronic pressure differential gauge 190 may have a first input operatively connected in fluid communication via a first hose 191 to the filter-receiving chamber 160 at an inlet 191a, may have a second input operatively connected in fluid communication via a second hose 192 to the collection chamber 170. As air flows along the closed-loop air flow circulation path “P”, and through the filter 106, the air pressure monitor 190 may thereby detect the air pressure differential between the filter-receiving chamber 160 and the collection chamber 170. The pressure is measured ten (10) times per second, or any suitable frequency. This pressure differential may be used to detect the back pressure, or in other words resistance to air flow, in the closed-loop air flow circulation path “P”. The back pressure reading for filters being tested may be about four (4) p.s.i. to about seven (7) p.s.i. for a clean filter, and may be higher for a partially clogged filter, and may be significantly higher for a very clogged filter. The back pressure reading will be compared to the OEM backpressure reading to determine the level of cleanliness of the filter.

In a third mode of operation that may be used subsequent to cleaning the filter 106, the sump pump 176 may be operational to remove the contaminants (soot and ash-laden liquid) from the collection chamber 170. This third mode of operation may be used periodically, such as once every ten to fifteen full cleaning cycles.

In another aspect of the present invention, there is disclosed a method of cleaning air filters 106. The method may comprise the steps of placing the filter 106 on the filter support 168 in a filter-receiving chamber 160 in the closed-loop air flow circulation path “P”, for subsequent cleaning and drying. Another step may comprise heating air for subsequent circulation along the filter 106. Heating of the air causes the time taken to dry the filter 106 to be decreased. The step of heating air for subsequent circulation along the filter 106 may be done such that the heated air may be immediately thereafter circulated along the filter 106. Another step may comprise circulating the heated air along the filter 106 to thereby evaporate moisture from the filter 106 and remove contaminants from the filter 106. Yet another step may comprise capturing contaminants in the air circulating in the closed-loop air flow circulation path “P”. The method may further comprise the step of monitoring the air pressure in the closed-loop air flow circulation path “P”, as air flows along the closed-loop air flow circulation path “P”, and through the filter 106, as described above.

As can be seen in the Figures, there may be a first supplemental air flow conduit 196 connected in air receiving relation to the air flow egress 158b, and that may have a capped outlet 196c. There also may be a second supplemental air flow conduit 198 connected in air delivery relation to the air flow conduit 188, and that may have a capped outlet 198c. The first supplemental air flow conduit 196 and the second supplemental air flow conduit 198 may be used to connect to a filter and clean a filter that is too large to fit into the collection chamber 170, such as a filter that may have pipes or similar secured to it, and may have been removed from a vehicle.

As can be understood from the above description and from the accompanying drawings, the present invention provides a system and apparatus for and method of cleaning air filters, wherein contaminants are thoroughly removed from the filters, wherein water used to rinse the filters is thoroughly removed from the filters so the filters are at least close to dry, wherein the filters may be used in diesel engines, wherein the system and apparatus are inexpensive to manufacture, wherein the system and apparatus are inexpensive to maintain, wherein the system and apparatus are inexpensive to operate, wherein the method is inexpensive to implement and execute, system, apparatus and method for extracting contaminants from contaminant-trapping filters, system and apparatus for and method of cleaning air filters, wherein contaminants are thoroughly removed from the filters, wherein water used to rinse the filters is thoroughly removed from the filters so the filters are at least close to dry, wherein the filters may be used in diesel engines, wherein the system and apparatus are inexpensive to manufacture, wherein the system and apparatus are inexpensive to maintain, wherein the system and apparatus are inexpensive to operate, wherein the method is inexpensive to implement and execute, all of which features are unknown in the prior art.

Other variations of the above principles will be apparent to those who are knowledgeable in the field of the invention, and such variations are considered to be within the scope of the present invention. Further, other modifications and alterations may be used in the design and manufacture of the system and apparatus for and method of cleaning air filters, exhaust filters, according to the present invention without departing from the spirit and scope of the accompanying claims.

1. An apparatus for cleaning air filters, said apparatus comprising:
a housing having a filter-receiving chamber that surrounds a filter to be cleaned and dried, an air flow ingress in fluid communication with said filter-receiving chamber, and an air flow egress in fluid communication with said filter-receiving chamber;
an air flow conduit connecting said air flow egress in air delivery relation to said air flow ingress;
wherein said air flow ingress, said housing including said filter-receiving chamber, and air flow conduit form a closed-loop air flow circulation path;
a filter support in said housing for supporting said filter to be cleaned and dried in said air flow circulation path;
a fan for circulating air along said air flow circulation path;
a heater mounted in said air flow path for heating the air circulating air along said air flow circulation path and delivering the heated air directly to said air flow ingress;
wherein said air flow ingress receives heated air from said heater and is positioned to deliver the heated air flow directly to said filter;
a contaminant filtration apparatus in said air flow circulation path for capturing contaminants in the air circulating in said air flow circulation path; and,
a control device for controlling the operation of said fan and heater.

2. The apparatus according to claim 1, wherein said filter-receiving chamber occupies the top portion of said housing.

3. The apparatus according to claim 1, wherein said filter support comprises a grate.

4. The apparatus according to claim 1, wherein said filter support comprises a wire mesh.

5. The apparatus according to claim 1, wherein said filter support is disposed adjacent the bottom of said filter-receiving chamber.

6. The apparatus according to claim 1, wherein said filter support defines the bottom extent of said filter-receiving chamber.

7. The apparatus according to claim 1, wherein said heater is disposed in said housing.

8. The apparatus according to claim 1, wherein said heater is disposed in said filter-receiving chamber.

9. The apparatus according to claim 1, wherein said heater is operatively disposed between said air flow ingress and said filter-receiving chamber.

10. The apparatus according to claim 1, wherein said heater is disposed in said closed-loop air flow circulation path immediately after said air flow ingress and said filter-receiving chamber.

11. The apparatus according to claim 1, wherein said heater is disposed in said closed-loop air flow circulation path to heat the circulating air as it enter said filter-receiving chamber.

12. The apparatus according to claim 1, wherein said contaminant filtration apparatus comprises a filter disposed over said air flow egress.

13. The apparatus according to claim 1, further comprising an air pressure monitor.

14. The apparatus according to claim 13, wherein said air pressure monitor comprises an electronic pressure differential gauge.

15. The apparatus according to claim 14, wherein said electronic pressure differential gauge is operatively connected in fluid communication to said filter-receiving chamber and said collection chamber.

16. The apparatus according to claim 1, further comprising a particulate receiving and retaining receptacle.

17. The apparatus according to claim 16, wherein said particulate receiving and retaining receptacle is disposed below said filter-receiving chamber.

18. The apparatus according to claim 16, wherein said particulate receiving and retaining receptacle is disposed below said air flow circulation path.

19. A method of cleaning air filters, said method comprising the steps of:
(a) Placing said filter on a filter support in a filter-receiving chamber in an air flow circulation path;
(b) Heating air for subsequent circulation along said filter prior to said air being introduced into said filter-receiving chamber;
(c) Introducing the heated air into the filter-receiving chamber and circulating the heated air along said filter to thereby evaporate moisture from said filter and remove contamination from said filter; and,
(d) Capturing contaminants from the air circulating in said air flow circulation path.

20. The method according to claim 19, wherein the step of heating air for subsequent circulation along said filter is done such that the heated air is immediately thereafter circulated along said filter.

21. The method according to claim 19, further comprising the step of monitoring the air pressure in said filter-receiving chamber and a collection chamber.
